(19) United States
(12) Patent Application Publication
(10) Pub. No.: US 2009/0113937 A1
(43) Pub. Date: May 7, 2009

(54) LIME GLASS BATCH COMPOSITION

(75) Inventors: Pierre Carleer, Jumet (BE); Olivier Collart, Jumet (BE); Benoit Chiliatte, Jumet (BE)

Correspondence Address: AKERMAN SENTERFITT, P.O. BOX 3188, WEST PALM BEACH, FL, 33402-3188, US

(73) Assignee: AGC Flat Glass Europe SA, Jumet (BE)

(21) Appl. No.: 12/302,543

(22) PCT Filed: Jun. 1, 2007
(86) PCT No.: PCT/EP2007/055401

§ 371 Date: Nov. 26, 2008

(30) Foreign Application Priority Data
Jun. 1, 2006 (EP) 06114866.4

(51) Int. Cl. C03B 18/02; C03C 6/04; C03C 6/10

(52) U.S. Cl. 65/95; 501/31; 501/28

(57) ABSTRACT

Lime glass batch composition wherein at least part of the limestone and/or the dolomite from the composition has been replaced by a synthetic aluminosilicate of calcium and magnesium.

### CROSS-REFERENCE TO RELATED APPLICATIONS

This application is the entry into the United States of PCT Application number PCT/EP2007/055401 filed Jun. 1, 2007 and claims priority from European application EP 06114866.4 filed Jun. 1, 2006, the entirety of each of which is hereby incorporated by reference.

### BACKGROUND

This invention relates to a lime glass batch composition and, especially to a lime glass batch comprising silicon, calcium, magnesium and aluminium, as well as a process for manufacturing flat lime glass sheets by melting the same composition.

There is known by U.S. Pat. No. 6,287,997 a method of producing a glass by mixing silica sand with a synthetic silicate and heating at about 1300-1400° C. to obtain molten glass. The synthetic silicate is a preheated mixture of a source of calcium and/or magnesium with a source of silicon dioxide.

In that known method, no glass comprising aluminum is obtained.

### SUMMARY

According to a first aspect, the invention provides a lime glass batch composition as defined in claim 1.

According to a second aspect, the invention provides a process for the manufacture of flat lime glass sheets as defined in claim 16.

Dependent claims define further preferred embodiments of the invention.

The present invention may provide one or more of the following advantages:
lowering of the gaseous CO₂ emissions;
lowering of the amount of heating energy required for melting the batch;
increase of the pull of molten glass from the furnace.

The lime glass batch composition according to the invention comprises batches suitable for the manufacture of any glass comprising calcium. Examples of those glasses are: soda-lime glass, boron glass, special glasses comprising arsenic, barium, strontium and/or zirconium, like those used for optical mirrors and lenses, for flat displays, etc.

The lime glass batch composition according to the invention is a mixture of silica sand, limestone, dolomite and a source of alumina wherein at least part of at least one of the limestone and the dolomite is replaced by a synthetic aluminosilicate of calcium and magnesium (hereafter referred to as “Ca—Mg—Al silicate”). The composition of that Ca—Mg—Al silicate, expressed in weight % of dry synthetic Ca—Mg—Al silicate, is as follows:
SiO₂: 14 to 26%;
Al₂O₃: 3 to 10%;
CaO+MgO: 59 to 74%.

In that batch composition, the source of alumina may comprise various Al containing compounds. Those Al compounds may be found in the nature as Al ores, like feldspar, nepheline and aluminum oxide. They may as well be synthetic compounds, resulting from a chemical treatment or being a by-product of another chemical or industrial process, like aluminum hydroxide and slag providing from steel factories. The source of alumina may consist of one single member of those Al compounds. Alternatively, it may as well comprise a mixture of two or more of those members.

In an advantageous embodiment of the invention, the source of alumina may as well be replaced, at least in part, by the synthetic Ca—Mg—Al silicate. Batch compositions wherein only part of the source of alumina has been replaced by synthetic Ca—Mg—Al silicate are preferred.

In another embodiment, which is compatible with the previous one, the synthetic Ca—Mg—Al silicate is a mixture of tri-Ca silicate Ca₃SiO₅ (or 3CaO.SiO₂), bi-Ca silicate Ca₂SiO₄ (or 2CaO.SiO₂), tri-Ca aluminate Ca₃Al₂O₆ (or 3CaO.Al₂O₃) and a small proportion of MgO not exceeding 3 wt. % of the mixture. Generally, Ca₃SiO₅, Ca₂SiO₄ and/or Ca₃Al₂O₆ are present into their crystallised form.

In that embodiment, especially preferred are the synthetic Ca—Mg—Al silicates wherein tri-Ca aluminate Ca₃Al₂O₆ is present both as a crystallised product and as an amorphous product. Most preferred are the batches wherein the crystallised weight proportion of the Ca₃Al₂O₆ is at least 60% of the total weight of the Ca₃Al₂O₆.

In another interesting embodiment of the invention, which is as well compatible with the previous embodiments, part of the aluminum may be replaced by iron. In that embodiment, no more than 50 weight % of the aluminum may preferably be replaced by iron. According to that embodiment, iron may be present under the form of tetra-Ca alumino-ferrite Ca₄Al₂Fe₂O₁₀, or 4CaO.Al₂O₃.Fe₂O₃. In the batch composition, Ca₄Al₂Fe₂O₁₀ may be present into a crystallised form and/or an amorphous form. The weight proportion of the crystallised form may vary from 20 to 90% of the total Ca₄Al₂Fe₂O₁₀ weight.

In any of the previous embodiments, each one of the Ca₃SiO₅, Ca₂SiO₄, Ca₃Al₂O₆ and Ca₄Al₂Fe₂O₁₀ species may be anhydrous, i.e. that they are not linked with any chemical water or do not physically retain any absorpted water on their surface. Each species may as well be present under both anhydrous and hydrated form. Preferably, all the species carry only a tiny content of water with them in the composition, not more than 10% of their total dry weight. Most preferably, all the species in the composition are anhydrous and completely free of water.

According to another preferred embodiment, the synthetic Ca—Mg—Al silicate in the batch composition is a cement clinker.

According to another embodiment, compatible as well with the previous ones, the batch composition comprises a flux. Preferably, the flux present into the composition is selected from sodium, potassium, lithium, boron, barium, arsenic, phosphorus and vanadium compounds. A mixture of several of those compounds may as well be selected as flux into the composition.

A preferred flux is soda ash, under the form of anhydrous Na₂CO₃. That flux is most preferred for the manufacture of soda-lime glass.

Besides the components detailed above, the batch composition according to the invention may also comprise common glass additives. Those additives are well known compounds used in glass making and fulfil the functions of colorants, oxidants, reductors, viscosity modifiers and fining agents. They are generally present in the batch mixture in minor proportions, lower than 4 wt. % each, and preferably lower than 2 wt. % each. Examples of those additives are, non-limitatively: Na₂SO₄, NaNO₃, Fe₂O₃, TiO₂, a rare earth oxide, C, a salt of Co, of Cr, of Cu, of Se, of Mn, of a rare earth, Mn oxides, V₂O₅ and Se. Several additives may be used together in the batch composition. Preferably, coloring additives are selected from at least one of a cobalt compound, a vanadium compound, a chromium compound, a manganese compound, a selenium compound and a rare earth compound.

In a second aspect, the invention provides a process for the manufacture of flat lime glass sheets by melting the batch composition according to the invention in a glass furnace, refining the melted batch, floating a ribbon of the melted glass composition on a liquefied tin bath to form a continuous flat glass ribbon, cooling it progressively, solidifying and annealing it, and finally cutting the solidified flat glass ribbon into separated flat glass sheets.

In that process, the synthetic aluminosilicate of calcium and magnesium may be added together with the other components. Alternatively, this Ca—Mg—Al silicate may be added to the batch separately, at least one particular location of the furnace. Ca—Mg—Al silicate is preferably introduced into the furnace under the form of particles of up to about 4 mm of diameter.

The invention relates as well to a flat soda-lime glass sheet manufactured by the process comprising the batch composition according to the invention.

### BRIEF DESCRIPTION OF DRAWING

The single FIGURE is a graph comparing rates of melting (time in minutes and % unmelted).

### DETAILED DESCRIPTION

The invention will now be illustrated below by examples aiming at better describing the invention, without by no means trying to limit its scope.

### Examples 1R and 2

Melting experiments have been performed in a laboratory electrical furnace using transparent quartz crucibles. A digital CCD camcorder has continuously recorded a melting materials area picture through the crucible walls and the pictures taken have been analysed with the aid of LUCIA software, from the Czech Laboratory Imaging company, in order to compute the percentage amount of the observed area which was not already melted into glass.

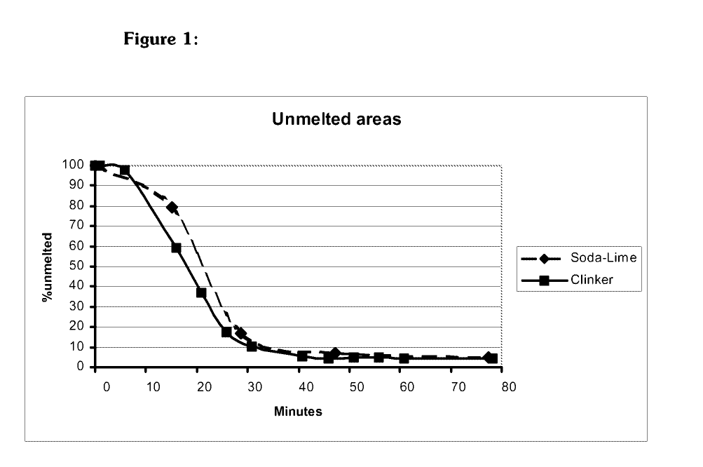

Three different batch compositions have been tested, results of which are given in Table 2 and FIG. 1 below. Batch 1R results correspond to a classical soda-lime batch composition. A second batch composition (example 2) according to the invention comprises cement clinker as the synthetic Ca—Mg—Al silicate, the composition of which is as follows:
SiO₂: 25 wt. %
Al₂O₃: 4 wt. %
CaO: 69 wt. %
MgO: 0.5 wt. %

Raw materials components and calculated chemical compositions of the two batches 1R and 2 are given in Table 1 below and show that experiments have been designed so as to keep constant that composition across the batches.

TABLE 1
Batch compositions

Amount, wt. %

| | | |
|---|---|---|
| | 1R | 2 |
| Example | Soda-lime | Clinker |

| | | | |
|---|---|---|---|
| Components | Sand | 58 | 58 |
| | Limestone | 4 | 0 |
| | Dolomite | 17 | 17 |
| | Feldspar | 2.5 | 2 |
| | Steel slag | 0 | 0 |
| | Soda-ash | 18 | 19 |
| | Cement clinker | 0 | 3 |
| Chemical | SiO₂ | 72 | 72 |
| composition | Al₂O₃ | 0.7 | 0.7 |
| | CaO | 8.9 | 8.9 |
| | MgO | 4.3 | 4.3 |
| | Na₂O | 13.6 | 13.6 |
| | K₂O | 0.18 | 0.18 |
| | Fe₂O₃ | 0.07 | 0.07 |

TABLE 2
Melting results (Percentage area of unmelted raw materials)

Example

| | | 1R | 2 |
|---|---|---|---|
| Time | Minutes | Soda-lime | Clinker |
| 00:00:00 | 0 | 100.0 | 100.0 |
| 00:00:51 | 1 | | 100.0 |
| 00:05:51 | 6 | | 98.0 |
| 00:15:00 | 15 | 79.5 | |
| 00:15:51 | 16 | | 59.0 |
| 00:20:51 | 21 | | 36.7 |
| 00:25:51 | 26 | | 17.5 |
| 00:28:46 | 29 | 17.0 | |
| 00:30:51 | 31 | | 10.1 |
| 00:40:51 | 41 | | 5.3 |
| 00:45:51 | 46 | | 4.5 |
| 00:47:13 | 47 | 6.9 | |
| 00:50:51 | 51 | | 4.9 |
| 00:55:51 | 56 | | 5.1 |
| 01:00:51 | 61 | | 4.4 |
| 01:17:22 | 77 | 4.9 | |
| 01:18:19 | 78 | | 4.4 |

It can be seen from Table 2 and FIG. 1 that melting unexpectedly occurs more rapidly for Example 2 comprising cement clinker than for the classical batch of Example 1R.

1. Lime glass batch composition comprising a source of silicon, a source of calcium, a source of magnesium and a source of aluminum, which is a mixture of silica sand, limestone, dolomite and a source of alumina, characterised in that at least part of at least one of the limestone and the dolomite is replaced by a synthetic aluminosilicate of calcium and magnesium (Ca—Mg—Al silicate) having the following compositional analysis, expressed in wt. % of dry synthetic Ca—Mg—Al silicate:
SiO₂: 14 to 26%;
Al₂O₃: 3to 10%;
CaO+MgO: 59 to 74%.

2. Lime glass batch composition according to claim 1, characterised in that the source of alumina comprises at least one of feldspar, steel factory slag, nepheline, aluminum hydroxide and aluminum oxide.

3. Lime glass batch composition according to claim 1, characterised in that part of the source of alumina is replaced by the synthetic Ca—Mg—Al silicate.

4. Lime glass batch composition according to claim 1, characterised in that the synthetic Ca—Mg—Al silicate is a mixture of crystallised tri-Ca silicate Ca₃SiO₅, crystallised bi-Ca silicate Ca₂SiO₄, tri-Ca aluminate Ca₃Al₂O₆ and a small proportion of MgO not exceeding 3 wt. % of the mixture.

5. Lime glass batch composition according to claim 4, characterised in that the tri-Ca aluminate Ca₃Al₂O₆ is at least part amorphous.

6. Lime glass batch composition according to claim 1, characterised in that part of the aluminum is replaced by iron.

7. Lime glass batch composition according to claim 6, characterised in that iron is present under the form of part amorphous tetra-Ca alumino-ferrite Ca₄Al₂Fe₂O₁₀.

8. Lime glass batch composition according to claim 1, characterised in that at least one of Ca₃SiO₅, Ca₂SiO₄, Ca₃Al₂O₆ and Ca₄AlFeO₁₀ is anhydrous.

9. Lime glass batch composition according to claim 1, characterised in that the synthetic Ca—Mg—Al silicate is a cement clinker.

10. Lime glass batch composition according to claim 1, characterised in that the composition comprises a flux.

11. Lime glass batch composition according to claim 10, characterised in that the flux is selected from sodium, potassium, lithium, boron, barium, arsenic, phosphorus and vanadium compounds.

12. Soda-lime glass batch composition according to claim 11, characterised in that the flux is soda ash (anhydrous Na₂CO₃).

13. Lime glass batch composition according to claim 1, characterised in that common glass additives in minor proportions lower than 2.0 wt. % each are present in the batch mixture.

14. Lime glass batch composition according to claim 13, characterised in that the additives are selected from at least one of colouring, oxidising, reducing, viscosity modifiers and/or fining materials: Na₂SO₄, NaNO₃, Fe₂O₃, TiO₂, a rare earth oxide, C, a salt of Co, of Cr, of Cu, of Se, of Mn, of a rare earth, Mn oxides, V₂O₅ and Se.

15. Lime glass batch composition according to claim 14, characterised in that the colouring material is at least one of a cobalt compound, a vanadium compound, a chromium compound, a manganese compound, a selenium compound and a rare earth compound.

16. Process for the manufacture of flat lime glass sheets by melting the batch composition according to claim 1 in a glass furnace, refining the melted batch, floating a ribbon of the melted glass composition on a liquefied tin bath to form a continuous flat glass ribbon, cooling it progressively, solidifying and annealing it, and finally cutting the solidified flat glass ribbon into separated flat glass sheets.

17. Flat soda-lime glass sheet manufactured by the process of claim 16.
